(19) United States
(12) Patent Application Publication
(10) Pub. No.: US 2018/0249679 A1
(43) Pub. Date: Sep. 6, 2018

(54) ANIMAL RECOGNITION AND LOCATION DEVICE

(71) Applicants: Katrina Goff CANDY, Echuca (AU); Ian Victor CHAFFEY, Tongala (AU); Geoffrey Thomas MACKENZIE, Moama (AU)

(72) Inventors: Katrina Goff CANDY, Echuca (AU); Ian Victor CHAFFEY, Tongala (AU); Geoffrey Thomas MACKENZIE, Moama (AU)

(21) Appl. No.: 15/758,129

(22) PCT Filed: Sep. 13, 2015
(86) PCT No.: PCT/IB2015/002096

§ 371 Date: Mar. 7, 2018

(51) Int. Cl. A01K 11/00; H04W 4/029; G06K 19/07; G09F 3/03

(52) U.S. Cl. CPC A01K 11/004; H04W 4/029; G09F 2003/0266; G09F 3/0347; G06K 19/0704

(57) ABSTRACT

The invention relates to an animal recognition and location arrangement in which the arrangement is easily attached to an animal. The arrangement comprises two components, a first component containing self powering and electronic communication features and a second component for attaching or securing the first component to the animal. The arrangement provides for unique identification information for the animal including location, and is also provided with a self-powering feature comprising a solar cell, and an illuminating feature, such as a light emitting diode for visually locating the animal at night. The first component of the arrangement also contains microcomputer devices for allowing electronic identification and location of the animal while the second component is constructed to allow for easy assembly of the first component to the animal.

### CROSS-REFERENCE TO RELATED APPLICATIONS

N/A

### FEDERALLY SPONSORED RESEARCH AND DEVELOPMENT APPENDICES

N/A

### SUMMARY OF THE INVENTION

The invention relates to an animal recognition and location arrangement in which the arrangement is easily attached to an animal. The arrangement comprises two components, a first component containing self powering and electronic communication features and a second component for attaching or securing the first component to the animal. The arrangement provides for unique identification information for the animal including location, and is also provided with a self-powering feature comprising a solar cell, and an illuminating feature, such as a light emitting diode (LED) for visually locating the animal at night. The first component of the arrangement also contains microcomputer devices for allowing electronic identification and location of the animal while the second component is constructed to allow for easy assembly of the first component to the animal.

### BACKGROUND OF THE INVENTION

Animal identification devices are known in the art which devices can be attached to an animal for use in properly identifying the animal and also used for providing information about the animal. Such information may include its birth date, animal breed, owner information, etc. However these devices lack the capability of providing location information, upon demand of the owner, or lack equipment assisting the owner in locating the animal. The instant invention provides an improvement in the identification devices and also allows an owner to locate the animal at will and further be able to visually locate the animal at night.

### BRIEF DESCRIPTION OF THE INVENTION

The invention relates to an animal recognition and location arrangement in which the arrangement is easily attached to an animal by the use and/or application of a female component containing self powering and electronic communication features and a second male component for attaching or securing the female component to the animal. The arrangement further provides for a unique identification and location system for facilitating the determination of the location and identity of an animal to the arrangement is attached by using electronic devices having a self-powering feature comprising a solar cell, and an illuminating feature, such as a light emitting diode (LED) for visually locating the animal at night. The female component of the arrangement contains microcomputer devices for allowing electronic identification via a global positioning satellite system or radio identification system while the male component is constructed to allow for easy assembly of the female component to the animal.

### BRIEF DESCRIPTION OF THE SEVERAL VIEWS OF THE DRAWINGS

FIG. 1 is various figures of the female component of the arrangement in accordance with the preferred embodiment of the invention.

FIG. 1a is a front view of the female component of the arrangement in accordance with the preferred embodiment of the invention.

FIG. 1b is a cut away cross-sectional view of the female component of the arrangement of FIG. 1a.

FIG. 1c is a cut away top view of the interior of the female component of the arrangement of FIG. 1b.

FIG. 1d is a cut away view of the FIG. 1b of the female component of the arrangement in accordance with the preferred embodiment of the invention.

FIG. 1e is a rear view of the female component of the arrangement in accordance with the preferred embodiment of the invention.

FIG. 1f is a side view of FIG. 1a of the female component of the arrangement in accordance with the preferred embodiment of the invention.

FIG. 2 is various figures of the two components of the arrangement in accordance with the preferred embodiment of the invention.

FIG. 2a is a side view of the component of the arrangement of FIG. 1 being used with the male component of the arrangement.

FIG. 2b is a side view of the assembled arrangement of FIG. 1 having been assembled with the male component of the arrangement.

FIG. 2c is a rear view of the male component of the arrangement of FIG. 2a.

FIG. 2d is a front view of the male component of the arrangement of FIG. 2a.

FIG. 3 is various figures of the female component of the arrangement in accordance with another embodiment of the invention.

FIG. 3a is a front view of the female component of the arrangement in accordance with another embodiment of the invention.

FIG. 3b is a rear view of the female component of the arrangement of FIG. 3a.

FIG. 3c is a cut away cross-sectional view of the interior of the female component of the arrangement of FIG. 3a.

FIG. 3d is a cross-sectional view of the FIG. 3c of the female component of the arrangement in accordance with another embodiment of the invention.

FIG. 3e is a cross-sectional front view of the FIG. 3c of the female component of the arrangement in accordance with another embodiment of the invention.

FIG. 4 is various figures of the two components of the arrangement in accordance with another embodiment of the invention.

FIG. 4a is a side view of the component of the arrangement of FIG. 3 being used with the male component of the arrangement.

FIG. 4b is a side view of the assembled arrangement of FIG. 3 having been assembled with the male component of the arrangement.

### DETAILED DESCRIPTION

For a more detailed description of the present invention, reference is made to the Figures.

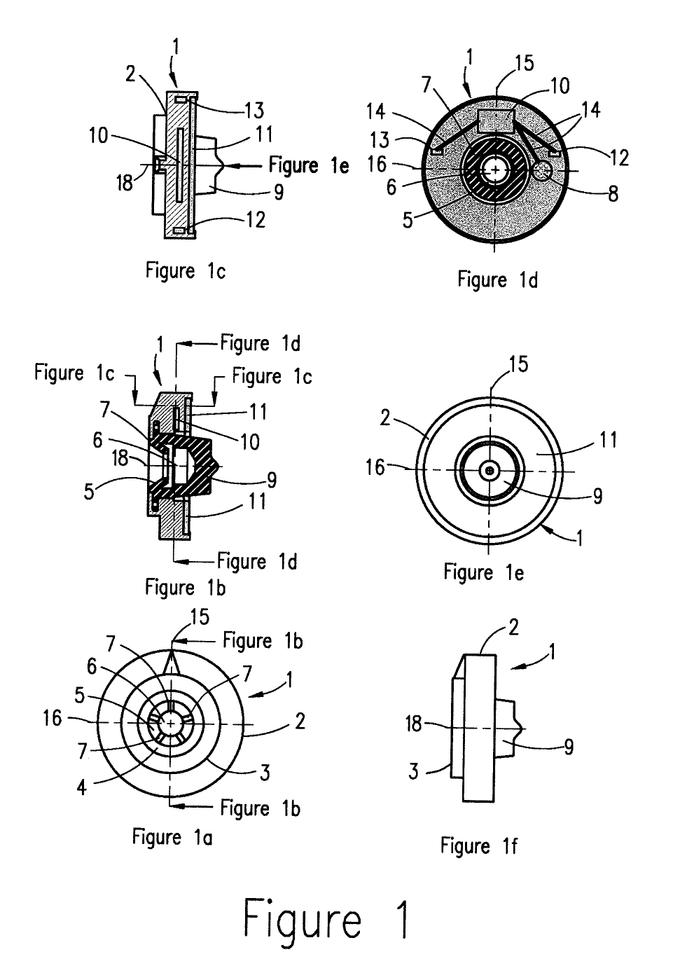

FIG. 1 comprises various figures of the arrangement according to the preferred embodiment of the invention.

FIG. 1a is a front view of the female component of an animal recognition and location arrangement showing female component 1 having a circular disc shape, an annular outer portion 2, and an inner annular portion 3. Additionally shown in FIG. 1a, female component 1 is also provided with an attachment centre portion 4, female attachment section 5, attachment centre portion 6 and spline sections 7. Also shown in FIG. 1a are the vertical centre-line 15 and horizontal centre-line 16 of the female component 1.

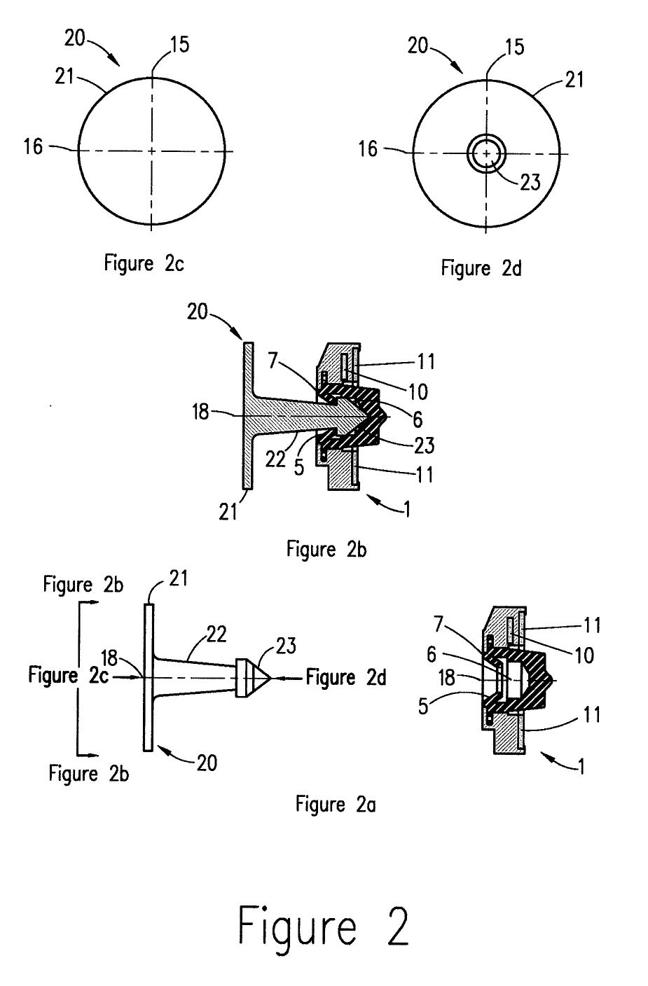

Now referring to FIG. 1b, a cut away cross-sectional view of the female component 1 of FIG. 1a is shown in detail. Particularly in FIG. 1b, the configuration of the interior of female component 1 is shown, particularly, attachment centre portion 6 comprising a female attachment section 5 capable of mating and securing with pointed male section 23 of male attachment piece 20, shown in greater detail and discussed in relation to FIGS. 2a and 2b. Also shown in FIG. 1b are spline sections 7, constructed to engage and secure with male attachment piece 20 of FIG. 2a, along with female component 1 centre-line 18 and female attachment rear section 9. Finally, FIG. 1b reveals cross sectional views of transmitter receiver microcomputer processor 10, also known as a microchip, and solar power panel 11 used to power female component 1, discussed further below.

Now referring to FIG. 1c, a cut away top view of the female component 1 of FIG. 1b is shown and as can be seem from FIG. 1c, female component 1 is provided, in its interior with a transmitter receiver microcomputer processor, also known as a microchip, 10, a pair of light emitting diodes, as known as LEDs, 12, and 13, and a solar power panel 11 used to power microcomputer processor 10 and LEDs 12 and 13. Microcomputer processor 10 is capable of being coded with information regarding the identity of an animal intended for use with the arrangement. This information may include, but is unlimited to, type and/or breed of the animal, birth date, owner, home location, etc. Additionally, the microcomputer processor 10 is programmed and capable of electronically communicating with and or transmitting information to and from a global positioning satellite device (GPS) or a radio frequency identification device for determining the location of the processor and any animal to which the arrangement is attached. The light emitting diodes (LEDs) 12 and 13 are electronically connected and operated by the microcomputer processor 10 particularly to activate either on demand by a user of the arrangement and/or during night-time conditions which are determined by the use of the solar panel 11 as will be disclosed in the discussion of FIG. 1d. Also shown in FIG. 1c are cross-sectional views of annular portion 2, female component attachment rear section 9 and female component 1 centre-line 18. Finally, the female component 1 is composed of translucent or transparent material preferably but unlimited to plastic or plastic-type material such that the translucent or transparent material allows for visibility of the light emitting diodes (LEDs) 12 and 13.

FIG. 1d is a cut away view of the FIG. 1b of female component 1 of the arrangement in accordance with the preferred embodiment of the invention and in particularly FIG. 1d reveals, in cross-sectional views, the configuration of interior components of female component 1 particularly LEDs 12 and 13, microcomputer processor 10 and electronic component 8. Although solar panel 11 is the main source of electrical power for microcomputer processor 10 and LEDs 12 and 13 for female component 1, electronic component 8 can comprise an electrical battery or other electrical power storage device for use in powering microcomputer 10 or LEDs 12 and 13. Electronic component 8 can also comprise a capacitor, or any other suitable electronic element for use in operating female component 1. Also shown in FIG. 1d are female attachment member 5, attachment centre portion 6 and spline section 7. Finally shown in FIG. 1d are female component 1 horizontal centre-line 16, vertical centre-line 15 and various electrical connectors 14 connecting the electrical components of female component 1.

FIG. 1e is a rear view of the first component of the arrangement in accordance with the preferred embodiment of the invention and in particular, FIG. 1e shows the opposite side of female component 1 of FIG. 1a. FIG. 1e reveals the disc shaped configuration of female component 1, annular outer portion 2, solar power panel 11 and female component attachment rear section 9. Finally, FIG. 1e shows vertical centre-line 15 and horizontal centre-line 16 of female component 1.

FIG. 1f is a side view of FIG. 1a of the first component of the arrangement in accordance with the preferred embodiment of the invention and in particular, FIG. 1f shows a side view of female component 1 of FIG. 1a revealing the configuration of annular outer portion 2, inner annular portion 3, female component attachment rear section 9 relative to centre-line 18.

FIG. 2 are various figures of the arrangement in accordance with the preferred embodiment of the invention.

FIG. 2a is a side view of the animal recognition arrangement of the preferred embodiment showing male attachment member 20 having disc portion 21, elongated male attachment section 22 and pronged male attachment end 23. Also shown in FIG. 2a, is the cross-sectional view of the female component 1, as previously shown in FIG. 1b, particularly, attachment centre portion 6 comprising a female attachment section 5 capable of mating and securing with pointed male section 23 of male attachment piece 20. FIG. 2a further shows that spline sections 7 are constructed to engage and secure with male attachment piece 20 along female component 1 centre-line 18. Finally, FIG. 2a reveals cross sectional views of transmitter receiver microcomputer processor 10 and solar power panel 11 of female component 1. Finally, FIG. 2a shows that the female attachment member 5, of FIG. 1a and as can be seen in FIG. 2a, male attachment member 20 is constructed and capable of aligning and mating with female attachment member 5.

FIG. 2b shows the assembled members 20 and 1 and particularly FIG. 2b shows the configuration of assembled arrangement. As FIG. 2b shows, in a cross-sectional view of male attachment member 20 having disc portion 21, on use or application of the arrangement, that male attachment member 20 mates and secures into female component 1 with pronged male attachment end 23 being receiving by female attachment section 5. FIG. 2b further reveals, in the assembled arrangement, in cross-sectional view, the configuration of the various interior components, in essence, attachment centre portion 6 and attachment section 5, pointed male section 23 of male attachment piece 20. FIG. 2b further shows spline sections 7 and female component centre-line 18 along with cross sectional views of transmitter receiver microcomputer processor 10 and solar power panel 11 of female component 1.

FIG. 2c is a rear view of the male component of the arrangement of FIG. 2a and particularly shows the circular configuration of both the male attachment member 20, and disc portion 21. Also shown in FIG. 2c are vertical centre-line 15 and horizontal centre-line 16. Finally male component 20 is composed of translucent or transparent material preferably but unlimited to plastic or plastic-type material such that the translucent or transparent material allows for visibility of the light emitting diodes (LEDs) 12 and 13 contained in female component 1.

FIG. 2d is a front view of the male component of the arrangement of FIG. 2a and particularly shows the circular configuration of both the male attachment member 20, showing disc portion 21 and of the pronged male attachment end 23. Also shown in FIG. 2d are vertical centre-line 15 and horizontal centre-line 16.

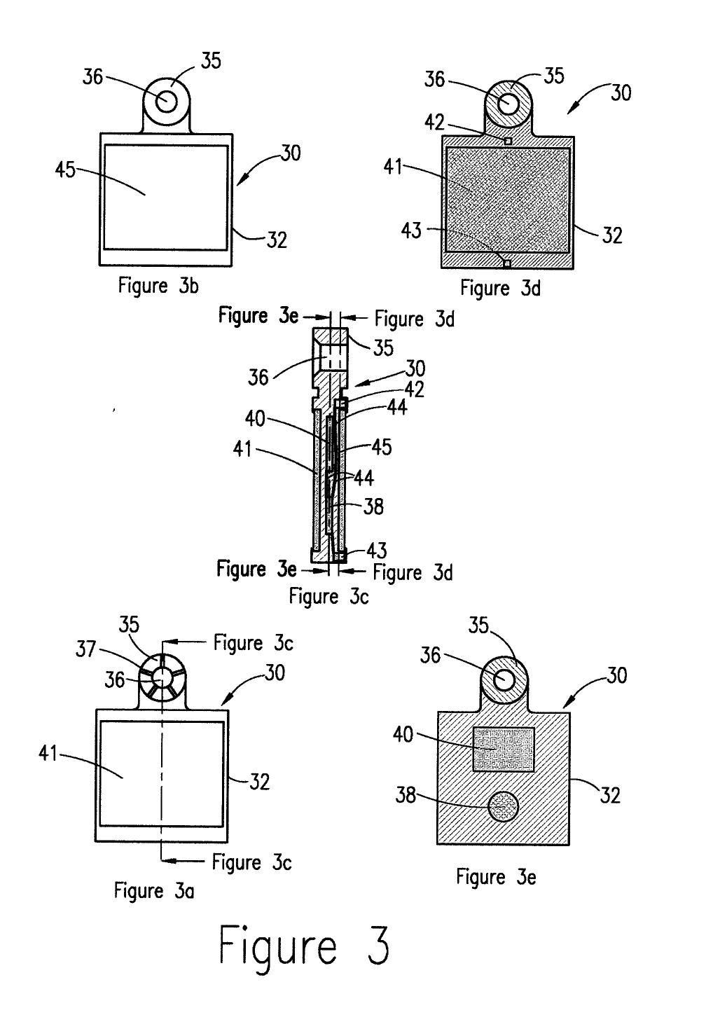

FIG. 3 comprises various figures of the arrangement according to another embodiment of the invention.

FIG. 3a is a front view of an animal recognition and location arrangement showing female component 30 having a rectangular shape, a rectangular outer portion 32, a female attachment section 35, attachment centre portion 36, spline sections 37 and power solar panel 41.

Now referring to FIG. 3b, a rear view of female component 30 of FIG. 3a is seen showing the configuration of outer rectangular portion 32, a female attachment section 35, attachment centre portion 36 and rear solar power panel 45.

FIG. 3c is a cut away cross-sectional view of the female component 30 of FIG. 3a. FIG. 3c shows the configuration of the interior of female component 30, particularly, the attachment centre portion 35 and attachment centre portion 36 capable of mating and securing with pointed male section 23 of male attachment piece 20 of FIG. 2, shown in greater detail in FIGS. 2a and 2b. Also shown in FIG. 3c is the configuration of light emitting diodes 42 and 43, solar power panels 41 and 45, a transmitter receiver microcomputer processor 40, and electronic component 38. As with microcomputer processor 10, microcomputer processor 40 is capable of being coded with information regarding the identity of an animal intended for use with the arrangement. This information may include, but is unlimited to, type and/or breed of the animal, birth date, owner, home location, etc. Additionally, the microcomputer processor 40 is programmed and capable of electronically communicating with and or transmitting information to and from a global positioning satellite device (GPS) or a radio frequency identification device for determining the location of the processor and any animal to which the arrangement is attached. The light emitting diodes (LEDs) 42 and 43 are electronically connected and operated by the microcomputer processor 40 particularly to activate either on demand by a user of the arrangement and/or during night-time conditions which are determined by the use of the solar panel 41 and/or 45 as will be disclosed in the discussion of FIG. 3d. Although solar panels 41 and 45 are the main source of electrical power for microcomputer processor 40 and LEDs 42 and 43, female component 30 is also provided with an electronic component 38. Electronic component 38 can comprise an electrical battery or other electrical power storage device for use in powering microcomputer 30 or LEDs 42 and 43 or electronic component 38 can comprise a capacitor, or any other suitable electronic element for operating female component 30. FIG. 3c also shows the various components electrically connected by electrical connectors 44. Finally, the female component 30 is composed of translucent or transparent material preferably but unlimited to plastic or plastic-type material such that the translucent or transparent material allows for visibility of the light emitting diodes (LEDs) 42 and 43.

FIG. 3d is a cross-sectional front view of FIG. 3c showing the internal details of female component 30 particularly solar panel member 41 and its configuration to female attachment member 35, attachment centre portion 36 and outer rectangular portion 32. Further, female component 30 is composed of translucent or transparent materials preferably but unlimited to plastic which translucency or transparency allows for visibility of the light emitting diodes (LEDs) 42 and 43 similar to the composition of the female component 1 discussed above.

FIG. 3e is another cross-sectional front view of FIG. 3c showing the interior details of the female component 30 particularly the location and configuration of microcomputer processor 40, electronic component 38, female attachment member 35, attachment centre portion 36 and outer rectangular portion 32.

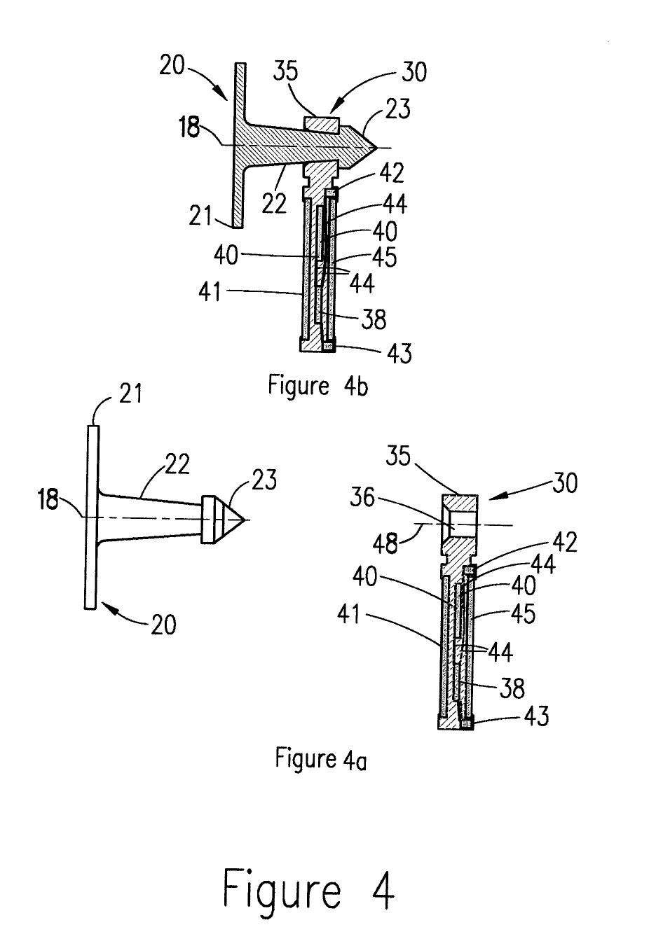

FIG. 4 are various figures of the arrangement in accordance with another embodiment of the invention

FIG. 4a is a side view of the animal recognition and location arrangement of the other embodiment showing male attachment member 20 having disc portion 21, elongated male attachment section 22 and pronged male attachment end 23 as previously shown and discussed relating to FIGS. 2a and 2b. Further shown in FIG. 4a, is female component 30, in cross-sectional view as shown in FIG. 3a, which, as previously disclosed, is provided with female attachment member 35 and attachment centre portion 36. FIG. 4a also shows all of the internal components and features of female component 30 as discussed in FIG. 3c. As can be seen in FIG. 4a, male attachment member 20 is constructed and capable of aligning, mating, and assembling along centre-line 18 of male attachment member 20 and centre-line 48 of female attachment member 35 through attachment centre portion 36 The assembly of male attachment member 20 and female component 30 is similar to the assembly of female component 1 and male attachment member 20 shown and discussed relating to FIGS. 2a and 2b.

FIG. 4b shows the assembled member and component 20 and 30 and particularly FIG. 4b shows the configuration of assembled arrangement. As FIG. 4b shows, in a cross-sectional view of male attachment member 20, on use or application of the arrangement, that male attachment member 20 mates and secures into female component 30 with pronged male attachment end 23 being receiving by female attachment section 35. FIG. 4b further reveals, in the assembled arrangement, in a cross-sectional view, the configuration of the various interior components of female component 30, in essence, attachment section 35 and pointed male prong section 23 of male attachment piece 20. FIG. 4b also shows all of the internal components and features of female component 30 as discussed in FIG. 3c.

Now having described the details of the several embodiments of the animal recognition and location arrangement, its use in facilitating the location and identity of the animal will now be described. Once it is determined that either female component 1 or 30, is to be attached to an animal, the female component is placed with its front side having its respective attachment centre abutting and adjacent to a suitable body part of the animal, usually an ear lobe. As an example, while female component 1 is held against the ear lobe, male attachment piece 20 is placed on the opposite side of the ear lobe, and driven thru the ear lobe, via pointed male section 23 into and secured to attachment centre portion 6 of female component 1. The entire assembly of the arrangement 1 and 20 remains affixed to the animal and then can then be activated electronically by transmitting a signal to the microcomputer processor 10 which is programmed to activate either via the GPS location signal, a radio frequency identification device or other suitable electronic activation device. The assembled arrangement can then be used to locate the animal via a GPS location signal, a radio frequency identification device or similarly electronic tracking system. Additionally, the microcomputer processor 10 is programmed to activate the LEDs 12 and 13 during night time, or other low light situations for a visually locating the animal. Although the above example details the assembly using assembled arrangement and electronic operation and function of components 1 and 20, female component 30 can be assembled to an animal in the same manner as with assembled arrangement 1 and 20 and operate electronically in a similar manner. Similarly, the electronic components of female component 30 are constructed in the same manner as those of female component 1.

The principles of the invention could be practiced by those of skilled in the art with equivalent alternative shapes. The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description; and all variations, substitutions and changes which come within the meaning and range of equivalency of the claims are therefore intended to be embraced therein.

When introducing elements of the present invention or the preferred embodiment(s) thereof, the articles “a”, “an”, “the”, and “said” are intended to mean there are one or more of the elements. The terms “comprising”, “including”, and “having” are intended to be inclusive and mean that there may be additional elements other than the listed elements.

The preceding written description and the accompanying drawings are intended solely as representative examples.

Only the appended claims and their equivalents define the scope of the protected invention.

The invention described herein is susceptible to variations, modifications and/or additions other than those specifically described and it is to be understood that the invention includes all such variations, modifications and/or additions which fall within the spirit and scope of the following claims.

1. An animal recognition and location arrangement comprising:
a male attachment member and
a female component whereby said female component is constructed to mate, secure and assemble with said male attachment member and wherein
said female component is provided with a plurality of electronic components for locating and identifying an animal to which said arrangement is attached and wherein
said male attachment member and female component are composed of material allowing for visibility of several of said plurality of electronic components contained in said female component whereby the assembled female component and male attachment member are attachable to said animal and said plurality of electronic components facilitate the determination of the location and identity of said animal.

2. The animal recognition and location arrangement of claim 1 wherein said male attachment member is provided with a disc portion and an elongated male attachment section and pronged male attachment end.

3. The animal recognition and location arrangement of claim 2 wherein said female component is of a circular configuration having an attachment centre portion, a female attachment section, spline sections whereby said female attachment section is constructed to mate, secure and assemble with said pronged male attachment end along a female component centre-line, and further whereby when said male attachment member and female attachment member are assembled together male attachment member mates and secures into female component with said pronged male attachment end being receiving by female attachment section and female attachment centre portion.

4. The animal recognition and location arrangement of claim 3 wherein said plurality of electronic components comprise a transmitter receiver microcomputer processor, a solar power panel, a plurality of light emitting diodes, an electronic component, and a plurality of electrical connectors connecting said microcomputer processor, said solar power panel, said light emitting diodes, and said electronic component wherein said transmitter receiver microcomputer processor and said light emitting diodes facilitate the determination of the location and identity of an animal to which the arrangement is attached.

5. The animal recognition and location arrangement of claim 4 wherein said material allowing for visibility of several of said plurality of electronic components of said male attachment member and female component comprises plastic translucent material.

6. The animal recognition and location arrangement of claim 4 wherein said material allowing for visibility of several of said plurality of electronic components of said male attachment member and female component comprises plastic transparent material.

7. The animal recognition and location arrangement of claim 4 wherein the electronic component comprises a battery.

8. The animal recognition and location arrangement of claim 4 wherein the electronic component comprises a capacitor.

9. The animal recognition and location arrangement of claim 4 wherein said one of said several of said plurality of electronic components comprises said plurality of light emitting diodes.

10. The animal recognition and location arrangement of claim 2 wherein said female component is of a rectangular configuration having an attachment centre portion, a female attachment section, spline sections whereby said female attachment section is constructed to mate and secure with said pronged male attachment end along a female component centre-line, and further whereby when said male attachment member and female attachment member are assembled together male attachment member mates and secures into female component with said pronged male attachment end being receiving by female attachment section and female attachment centre portion.

11. The animal recognition and location arrangement of claim 10 wherein said plurality of electronic components comprise a transmitter receiver microcomputer processor, at least a first solar power panel, a plurality of light emitting diodes, an electronic component, and electrical connectors connecting said microcomputer processor said first solar power panel said plurality of light emitting diodes and said electronic component wherein said transmitter receiver microcomputer processor and plurality of light emitting diodes facilitate the determination of the location and identity of an animal to which the arrangement is attached.

12. The animal recognition and location arrangement of claim 11 wherein said material allowing for visibility of several of said plurality of electronic components of said male attachment member and female component comprises plastic translucent material.

13. The animal recognition and location arrangement of claim 11 wherein said material allowing for visibility of several of said plurality of electronic components of said male attachment member and female component comprises plastic transparent material.

14. The animal recognition and location arrangement of claim 11 wherein the electronic component comprises a battery.

15. The animal recognition and location arrangement of claim 11 wherein the electronic component comprises a capacitor.

16. The animal recognition and location arrangement of claim 10 wherein one of said several of said plurality of components comprises said light emitting diodes.

17. The animal recognition and location arrangement of claim 11 wherein provided with a plurality of solar panels.

18. An animal recognition and location arrangement comprising:
a male attachment member having a disc portion and an elongated male attachment section and pronged male attachment end, and
a female component having a circular configuration and an outer annular portion, an inner annular portion, a rear attachment portion, an attachment centre portion, a female attachment section, and spline sections whereby said female attachment section is constructed to mate and secure with said pronged male attachment end along a female component centre-line, and further whereby when said male attachment member and female attachment member are assembled together male attachment member mates and secures into female component with said pronged male attachment end being receiving by female attachment section and female attachment centre portion and attachment section, and wherein
said female component is provided with a transmitter receiver microcomputer processor, a solar power panel, and a plurality of light emitting diodes, an electronic component comprising an electrical battery, and electrical connectors connecting said microcomputer processor, said solar power panel, said plurality of light emitting diodes and said electrical battery wherein said transmitter receiver microcomputer processor and said light emitting diodes and wherein
said female component is composed of transparent material composed of plastic material such that the transparent material allows for visibility of said plurality of light emitting diodes contained in said female component, and wherein
said male attachment member has a vertical centre-line and a horizontal centre-line and wherein
said male component is composed of transparent material comprising plastic material such that the transparent material allows for visibility of said plurality of light emitting diodes contained in said female component whereby the assembled female component and male member are attachable to an animal and said transmitter receiver microcomputer processor and said plurality of light emitting diodes facilitate the determination of the location and identity of said animal.

19. An animal recognition and location arrangement comprising:
a male attachment member having a disc portion and an elongated male attachment section and pronged male attachment end, and
a female component having a rectangular configuration and an outer rectangular portion, an attachment centre portion, a female attachment section, spline sections whereby said female attachment section is constructed to mate and secure said pointed male along a female component centre-line, and further whereby when said male attachment member and said female attachment member are assembled together male attachment member mates and secures into female component with said pronged male attachment end being receiving by female attachment section and female attachment centre portion and wherein
said female component is provided with a transmitter receiver microcomputer processor, a plurality of solar power panels, and a plurality of light emitting diodes, an electronic component comprising an electrical battery, and electrical connectors connecting said microcomputer processor, said plurality of solar power panels, said plurality of light emitting diodes, and said electrical battery and wherein said transmitter receiver microcomputer processor and said plurality of light emitting diodes can facilitate the determination of the location and identity an animal to which the arrangement is attached and wherein
said female component is composed of transparent material compose of plastic material whereby said transparent material allows for visibility of said plurality of light emitting diodes contained in said female component and wherein
said male attachment member has a vertical centre-line and a horizontal centre-line and wherein
said male component is composed of transparent material comprising plastic material such that the transparent material allows for visibility of said plurality of light emitting diodes contained in said female component whereby the assembled female component and male attachment member are attachable to an animal and said transmitter receiver microcomputer processor and plurality of light emitting diodes facilitate the determination of the location and identity of said animal.
